(19) United States
(12) Patent Application Publication
(10) Pub. No.: US 2019/0102396 A1
(43) Pub. Date: Apr. 4, 2019

(54) SYSTEMS AND METHODS FOR RANKING POTENTIAL RECIPIENTS OF CONTENT ITEMS ASSOCIATED WITH A SOCIAL NETWORKING SYSTEM

(71) Applicant: Facebook, Inc., Menlo Park, CA (US)

(72) Inventors: Lu Pan, Foster City, CA (US); Zhengyu Su, Jersey City, NJ (US); Chenyang Yu, Fremont, CA (US); Emma Dora Ruth Ziegellaub Eichler, New York, NY (US)

(21) Appl. No.: 15/724,144

(22) Filed: Oct. 3, 2017

(51) Int. Cl. G06F 17/30; G06F 7/08; G06N 99/00; H04L 12/58; H04L 29/08

(52) U.S. Cl. CPC G06F 17/3053; G06F 7/08; G06F 17/30554; H04M 1/72552; H04L 51/32; H04L 67/36; H04L 51/28; G06N 99/005

(57) ABSTRACT

Systems, methods, and non-transitory computer readable media can determine a plurality of potential recipients of a content item associated with a user. The plurality of potential recipients can be ranked based on a likelihood of the user engaging with the plurality of potential recipients. At least some of the plurality of potential recipients can be provided in a sheet for selecting one or more recipients of the content item, based on the ranking.

### FIELD OF THE INVENTION

The present technology relates to the field of social networks. More particularly, the present technology relates to techniques for ranking potential recipients of content items associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access.

### SUMMARY

Various embodiments of the present disclosure can include systems, methods, and non-transitory computer readable media configured to determine a plurality of potential recipients of a content item associated with a user. The plurality of potential recipients can be ranked based on a likelihood of the user engaging with the plurality of potential recipients. At least some of the plurality of potential recipients can be provided in a sheet for selecting one or more recipients of the content item, based on the ranking.

In some embodiments, the content item is an ephemeral message, and the sheet for selecting one or more recipients is a send sheet for the ephemeral message.

In certain embodiments, the ranking the plurality of potential recipients is based on ranking criteria.

In an embodiment, the ranking criteria includes one or more of: a send count for ephemeral message to a potential recipient within a time period, a send count for messages to a potential recipient within a time period, a receive count for ephemeral messages from a potential recipient within a time period, a receive count for messages from a potential recipient within a time period, a coefficient associated with a connection between the user and a potential recipient in a social networking system, or a coefficient associated with a connection between the user and a potential recipient in an application associated with a social networking system.

In some embodiments, the ranking the plurality of potential recipients is based on a machine learning model.

In certain embodiments, the machine learning model is trained based on features relating to one or more of: user attributes, message attributes, or interaction attributes.

In an embodiment, the content item is a media content item in a feed of the user, and the sheet for selecting one or more recipients is a share sheet for sharing the media content item.

In some embodiments, the ranking the plurality of potential recipients is based on ranking criteria.

In certain embodiments, wherein the ranking criteria includes one or more of: a share count for a potential recipient within a time period, a coefficient associated with a connection between the user and a potential recipient in a social networking system, or a coefficient associated with a connection between the user and a potential recipient in an application associated with a social networking system.

In an embodiment, the plurality of potential recipients includes one or more of: a connection of the user, or a group that includes a connection of the user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content item recipient ranking module configured to rank potential recipients of content items, according to an embodiment of the present disclosure.

FIG. 2A illustrates an example send sheet ranking module configured to rank potential recipients of ephemeral messages, according to an embodiment of the present disclosure.

FIG. 2B illustrates an example share sheet ranking module configured to rank potential recipients of media content items, according to an embodiment of the present disclosure.

FIGS. 3A-3D illustrate example scenarios for ranking potential recipients of content items, according to an embodiment of the present disclosure.

FIG. 4 illustrates an example first method for ranking potential recipients of content items, according to an embodiment of the present disclosure.

FIG. 5 illustrates an example second method for ranking potential recipients of content items, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Ranking Potential Recipients of Content Items Associated with a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

Conventional approaches specifically arising in the realm of computer technology can allow users of a social networking system to send or share content items. For example, users can send and receive various types of content items, such as messages and media content items. As an example, a user can choose to send a message and indicate one or more recipient users to receive the message. As another example, a user can choose to share a media content item and indicate one or more recipient users with whom to share the media content item. For instance, a user who wants to send or share a content item can select one or more recipient users from a list of users. Conventional approaches may provide the list of users without ranking users. For example, users in the list may be provided in an alphabetical order without ranking based various factors.

An improved approach rooted in computer technology can overcome the foregoing and other disadvantages associated with conventional approaches specifically arising in the realm of computer technology. Based on computer technology, the disclosed technology can rank potential recipients of various content items. Potential recipients of a content item that a user is sending or sharing can include connections of the user or groups that include connections of the user. The disclosed technology can rank potential recipients of a content item to be sent or shared by a user based on a likelihood of the user engaging with the potential recipients. In some embodiments, the disclosed technology can rank potential recipients of ephemeral messages. A user can capture media content in a camera view of a computing device of the user and choose to send the captured media content to one or more recipients as an ephemeral message. An ephemeral message can expire after a time period or after access by recipients. The user can select one or more recipients from a send sheet that includes potential recipients of an ephemeral message. The disclosed technology can rank the potential recipients to be included in the send sheet based on a likelihood of the user engaging with the potential recipients. As an example, the potential recipients can be ranked based on specified criteria. As another example, the potential recipients can be ranked based on machine learning techniques. The potential recipients can be provided in the send sheet based on the ranking. In certain embodiments, the disclosed technology can rank potential recipients of media content items in a feed of a user. The user can choose to share a media content item in the user's feed and select one or more recipients from a share sheet that includes potential recipients of the media content item. The disclosed technology can rank the potential recipients to be included in the share sheet based on a likelihood of the user engaging with the potential recipients, and the potential recipients can be provided in the share sheet based on the ranking. In this manner, the disclosed technology can provide potential recipients of content items, such as ephemeral messages and media content items in a feed, in an order that is customized and relevant for a particular user. Additional details relating to the disclosed technology are provided below.

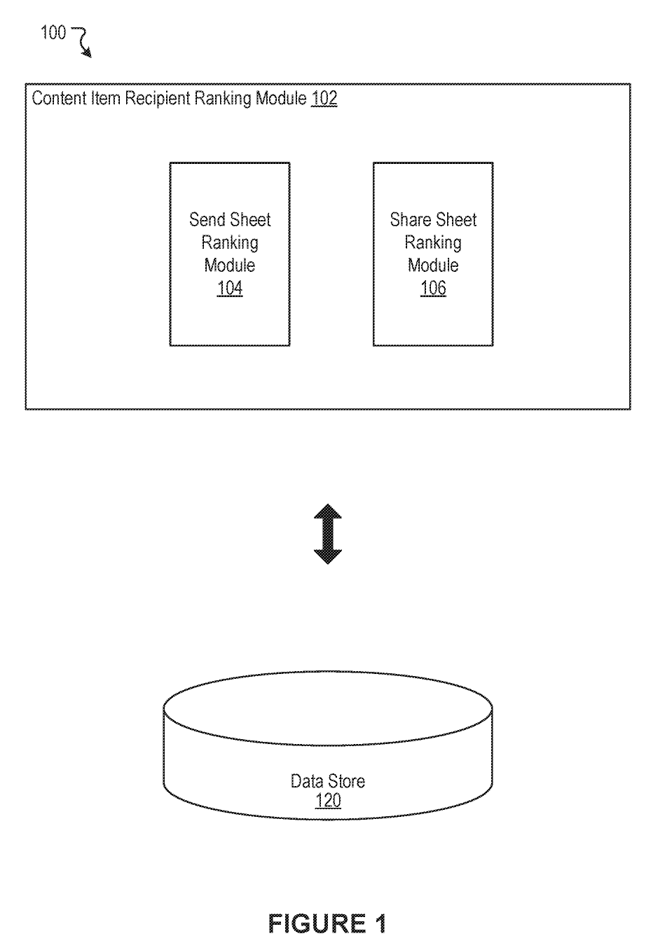

FIG. 1 illustrates an example system 100 including an example content item recipient ranking module 102 configured to rank potential recipients of content items, according to an embodiment of the present disclosure. The content item recipient ranking module 102 can include a send sheet ranking module 104 and a share sheet ranking module 106. The send sheet ranking module 104 and the share sheet ranking module 106 are separately discussed in more detail below. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the content item recipient ranking module 102 can be implemented in any suitable combinations. While the disclosed technology is described in connection with potential recipients of content items associated with a social networking system for illustrative purposes, the disclosed technology can apply to any other type of system and/or content.

A social networking system can provide various types of content items. For example, the content items can include messages (e.g., instant messages), media content items (e.g., images, videos, audios), etc. Content items provided by the social networking system can include ephemeral content items. An ephemeral content item can refer to any type of content that is accessible only for a predetermined time period (e.g., second(s), minute(s), hour(s), day(s), etc.) or for a predetermined number of times (e.g., once, twice, etc.). For example, an ephemeral content item can expire after the predetermined time period passes or can expire upon or after access (e.g., viewing) by a recipient user. In some instances, an ephemeral content item may be removed from servers and/or storage devices after expiration so that they are not accessible after their expiration. As an example, an ephemeral content item can be a message between users. As another example, an ephemeral content item can be a media content item, such as an image or a video. As used herein, any content item that is not ephemeral can be referred to as a non-ephemeral content item.

Potential recipients of a content item, such as an ephemeral message or a media content item in a feed, can include connections of a user sending or sharing the content item as well as groups that include connections of the user. In some embodiments, a connection between two users is two-way such that when the connection is established between a first user and a second user, the two users are connections of each other. In other embodiments, a connection between two users can be one-way such that a first user is a connection of a second user, but the second user is not a connection of the first user. In these embodiments, users can be subscribers or followers of other users. In some embodiments, groups that include connections of the user sending or sharing the content item can be determined based on threads (e.g., message threads) that include more than one connection of the user. For example, if a thread includes User A and User B, who are connections of the user, a group that includes User A and User B can be determined to be a potential recipient of a content item. Threads can include threads for non-ephemeral messages as well as threads for ephemeral messages. A user who sends or chooses to send an ephemeral message can be referred to as a “sending user.” A user who shares or chooses to share a media content item in a feed can be referred to as a “sharing user.” A send sheet can include potential recipients of an ephemeral message by a sending user. A share sheet can include potential recipients of a media content item to be shared by a sharing user. Potential recipients to be included in a send sheet or a share sheet can be ranked, as described below.

The send sheet ranking module 104 can rank potential recipients of ephemeral messages. In some cases, a sending user can capture image data from a camera view associated with a computing device of the sending user and create a media content item. The sending user can choose to send the captured media content item as an ephemeral content item, such as an ephemeral message. The sending user can indicate or select one or more recipients of the ephemeral message in a send sheet. The send sheet ranking module 104 can rank potential recipients to be included in a send sheet based on a likelihood of a sending user engaging with the potential recipients. For example, a user can engage with another user within a social networking system through various interactions, such as liking a post or other content items of the other user, commenting on content items of the other user, sharing a post or other content items with the other user, sending messages to the other user, etc. Functionality of the send sheet ranking module 104 is described in more detail herein.

The share sheet ranking module 106 can rank potential recipients of a media content item to be shared. In some cases, media content items can be provided in a feed of a sharing user. The sharing user can share one or more media content items in the sharing user's feed with other users. For instance, the sharing user can select an option to share a particular media content item, and indicate or select one or more recipients in a share sheet. The share sheet ranking module 106 can rank potential recipients to be included in a share sheet based on a likelihood of a sharing user engaging with the potential recipients. As described above, a user can engage with another user within a social networking system through various interactions. Functionality of the share sheet ranking module 106 is described in more detail herein.

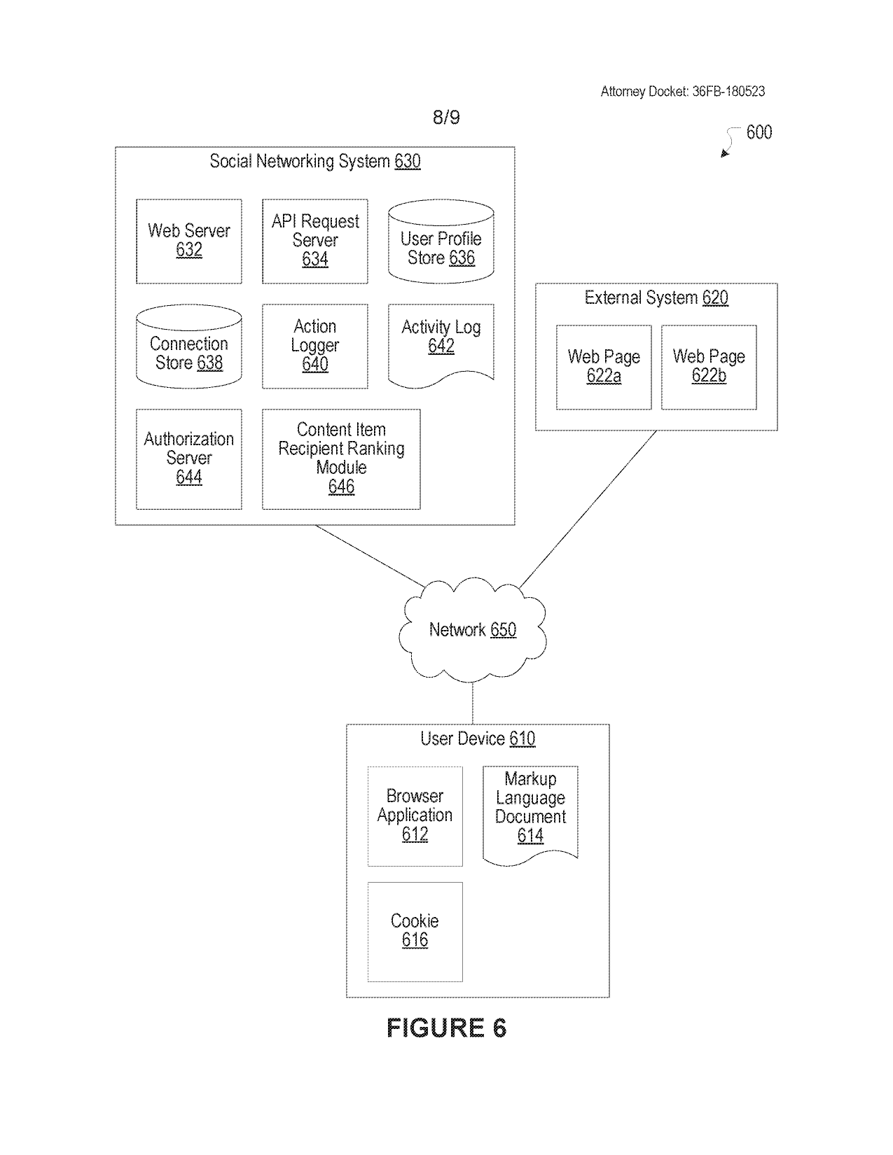

In some embodiments, the content item recipient ranking module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content item recipient ranking module 102 can be, in part or in whole, implemented as software running on one or more computing devices or systems, such as on a server system or a client computing device. In some instances, the content item recipient ranking module 102 can be, in part or in whole, implemented within or configured to operate in conjunction or be integrated with a social networking system (or service), such as a social networking system 630 of FIG. 6. Likewise, in some instances, the content item recipient ranking module 102 can be, in part or in whole, implemented within or configured to operate in conjunction or be integrated with a client computing device, such as the user device 610 of FIG. 6. For example, the content item recipient ranking module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the content item recipient ranking module 102. The data maintained by the data store 120 can include, for example, information relating to content items, direct messages, ephemeral messages, media content items, send sheets, share sheets, potential recipients, machine learning models, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the content item recipient ranking module 102 can be configured to communicate and/or operate with the data store 120. In some embodiments, the data store 120 can be a data store within a client computing device. In some embodiments, the data store 120 can be a data store of a server system in communication with the client computing device.

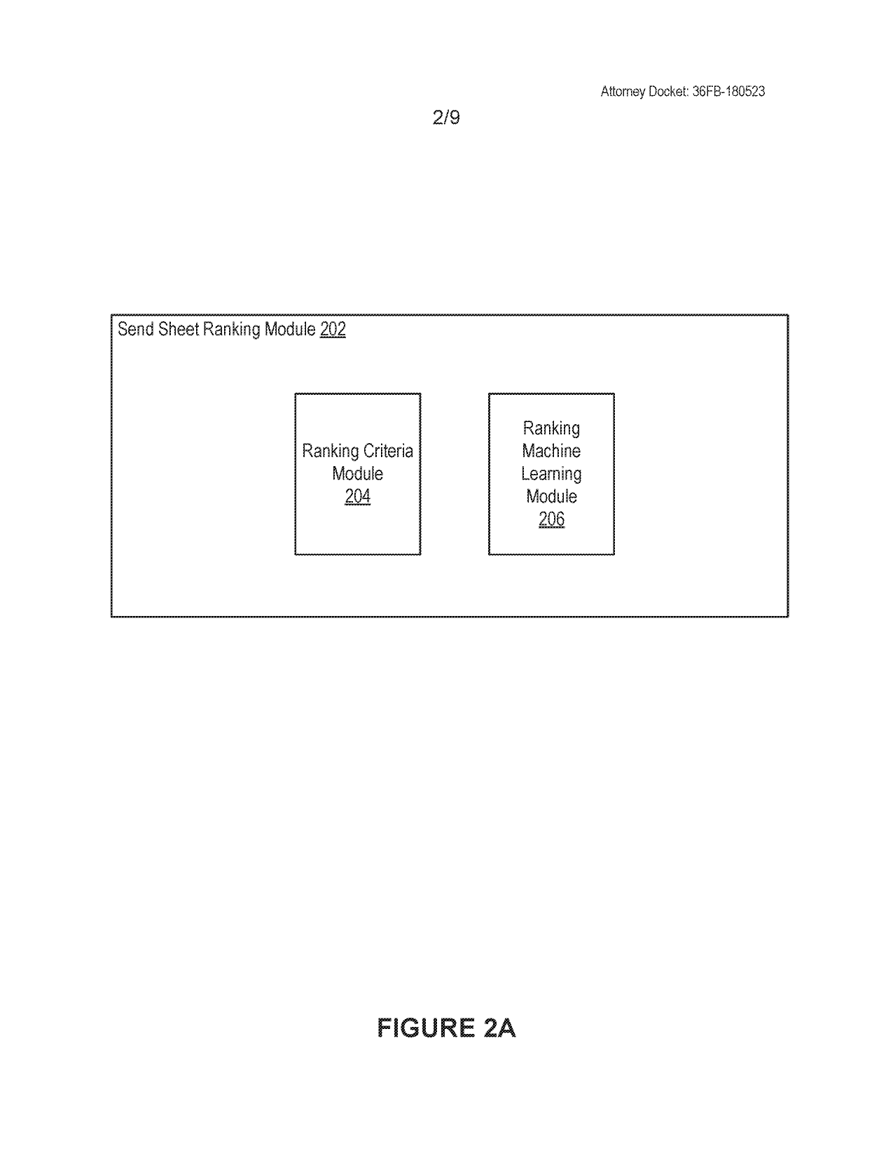

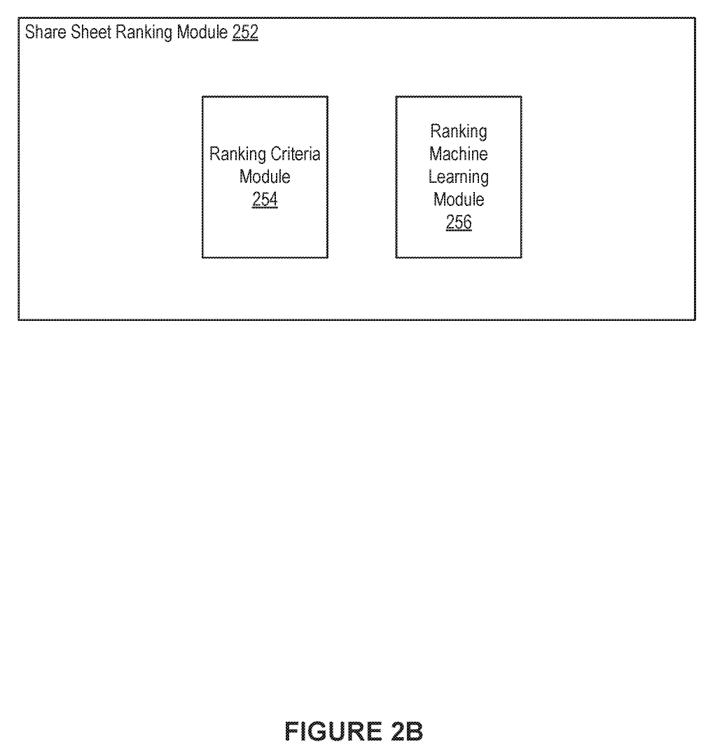

FIG. 2A illustrates an example send sheet ranking module 202 configured to rank potential recipients of ephemeral messages, according to an embodiment of the present disclosure. In some embodiments, the send sheet ranking module 104 of FIG. 1 can be implemented with the example send sheet ranking module 202. As shown in the example of FIG. 2A, the example send sheet ranking module 202 can include a ranking criteria module 204 and a ranking machine learning module 206.

As explained above, a sending user can access a camera view associated with a computing device of the sending user in order to create a media content item to send as an ephemeral message. An ephemeral message of the sending user can be sent in a thread. In some embodiments, separate threads can be created for ephemeral messages and non-ephemeral messages between a sending user and a recipient. In other embodiments, the same thread can include both ephemeral messages and non-ephemeral messages between a sending user and a recipient. Threads including ephemeral messages can be provided in an inbox of a user. In some embodiments, threads including ephemeral messages can be provided in an ephemeral message feed of a user, for example, provided in an inbox of the user.

The ranking criteria module 204 can rank potential recipients for a send sheet based on ranking criteria. Ranking criteria for a send sheet can include any criteria or information relevant for ranking potential recipients of an ephemeral message. The ranking criteria can include one or more factors for ranking potential recipients. In certain embodiments, the ranking criteria can include factors, such as a send count for ephemeral messages to a potential recipient within a time period, a send count for messages to a potential recipient within a time period, a receive count for ephemeral messages from a potential recipient within a time period, a receive count for messages from a potential recipient within a time period, a coefficient associated with a connection between a sending user and a potential recipient in a social networking system, and a coefficient associated with a connection between a sending user and a potential recipient in an application associated with a social networking system. The send count for ephemeral messages to a potential recipient within a time period can indicate a number of times a sending user sent an ephemeral message to the potential recipient within a time period. The send count for messages to a potential recipient within a time period can indicate a number of times a sending user sent any type of message to the potential recipient within a time period. The receive count for ephemeral messages from a potential recipient can indicate a number of times a sending user received an ephemeral message from the potential recipient within a time period. The receive count for messages from a potential recipient can indicate a number of times a sending user received any type of message from the potential recipient within a time period. A time period can be specified in an appropriate unit of time, such as hour(s), day(s), month(s), etc. A coefficient or weight associated with a connection between a user and a potential connection can be indicative of a strength of the connection. A user and a potential recipient can be connections within the social networking system or one or more applications associated with the social networking system, and corresponding coefficients for the connections between the user and the potential recipient can be considered in ranking potential recipients. In some embodiments, the user may not be very active in the social networking system. For example, an activity level of the user in the social networking system may not satisfy a threshold value. In these embodiments, if the user and the potential recipient are connections in one or more applications associated with the social networking system, coefficients of the connections between the two users in the one or more applications can be considered in ranking potential recipients. In certain embodiments, a potential recipient can be a group, and coefficients of individual users in the group can be aggregated (e.g., summed or averaged) in order to determine the coefficient for the group.

The ranking criteria module 204 can rank potential recipients for a send sheet based on the one or more factors in the ranking criteria. For example, for a sending user, a potential recipient having a higher send count within a specified time period can be ranked higher than a potential recipient having a lower send count within the specified time period. As another example, for a sending user, a potential recipient having a higher receive count within a specified time period can be ranked higher than a potential recipient having a lower receive count within the specified time period. As yet another example, for a sending user, a potential recipient having a higher value of a coefficient can be ranked higher than a potential recipient having a lower value of the coefficient. The ranking criteria module 204 can rank the potential recipients based on a combination of the one or more factors. In some embodiments, the one or more factors can be weighted. Many variations are possible.

The ranking machine learning module 206 can additionally or alternatively rank potential recipients for a send sheet based on machine learning techniques. For example, the ranking machine learning module 206 can train a machine learning model to rank potential recipients for a send sheet based on a likelihood of a sending user engaging with the potential recipients. For example, the machine learning model can be trained based on training data (e.g., labeled data) that includes information relating to sending users, recipients, ephemeral messages and/or non-ephemeral messages between sending users and recipients, interactions between sending users and recipients, whether sending users engaged with recipients, etc. The training data can include various features. For example, features can be selected from user attributes, message attributes, interaction attributes, etc. User attributes can include any attributes associated with users. User attributes can include attributes associated with sending users and attributes associated with recipients. Examples of user attributes can include a location (e.g., a country, state, county, city, etc.), an age, an age range, a gender, a language, a number of connections (e.g., friends or followers), interests (e.g., topics in which the user has expressed interest), a computing device, an operating system (OS), etc. Message attributes can include any attributes associated with messages between sending users and recipients. Message attributes can include attributes associated with ephemeral messages and attributes associated with non-ephemeral messages. Examples of message attributes can include a send count for messages to a recipient, a receive count for ephemeral messages from a recipient, a receive count for messages from a recipient, a number of threads including a recipient, recency of a message to a recipient, a number of views associated with messages, a number of views associated with ephemeral messages, whether a recipient responded to a message, etc. The send counts and the receive counts can be the same as or similar to the send counts and receive counts discussed above. Interaction attributes can include any attributes associated with interactions between sending users and recipients, for example, within a social networking system and/or applications associated with the social networking system. Examples of interaction attributes can include a number of likes, a number of comments, an amount of time spent on content items (e.g., photos, videos, etc.), an amount of overall time spent, etc. Many variations are possible. Values of various message attributes and interaction attributes can be determined for a specific time period and reflect data from the specific time period. A time period can be specified in an appropriate unit of time, such as hour(s), day(s), month(s), etc. For example, a send count for all messages can be determined for past 1 day, past 8 days, past 14 days, etc. The ranking machine learning module 206 can train the machine learning model to output a ranking or a score indicative of a likelihood of a sending user engaging with a potential recipient. Weights associated with various features used to train the machine learning model can be determined. The ranking machine learning module 206 can retrain the machine learning model based on new or updated training data.

The ranking machine learning module 206 can apply the trained machine learning model to rank potential recipients for a send sheet of a sending user. For example, the trained machine learning model can be applied to feature data relating to the sending user and the potential recipients to determine a likelihood of the sending user engaging with the potential recipients. For example, the trained machine learning model can output a ranking or a score for each potential recipient. One or more machine learning models discussed in connection with the content item recipient ranking module 102 and its components can be implemented separately or in combination, for example, as a single machine learning model, as multiple machine learning models, as one or more staged machine learning models, as one or more combined machine learning models, etc.

The send sheet ranking module 202 can provide some or all of the ranked potential recipients in the send sheet based on the ranking. In some embodiments, all of the potential recipients can be provided in the send sheet in the order of the ranking. In other embodiments, one or more top ranked potential recipients can be provided in the send sheet as suggested recipients. For instance, the top ranked potential recipients can be provided at the top of the send sheet or in other prominent ways. As an example, one or more potential recipients having rankings or scores that satisfy a threshold value can be provided as suggested recipients. As another example, a predetermined number of top ranked potential recipients can be provided as suggested recipients. In these embodiments, the send sheet can also provide some or all remaining potential recipients in an alphabetical order, for example, below the suggested recipients. In certain embodiments, the send sheet can also provide recent recipients, for example, below the suggested recipients. Recent recipients can indicate potential recipients who have received ephemeral messages or other content items from a sending user within a time period. The time period can be specified in an appropriate unit of time, such as hour(s), day(s), month(s), etc. Many variations are possible. All examples herein are provided for illustrative purposes, and there can be many variations and other possibilities.

FIG. 2B illustrates an example share sheet ranking module 252 configured to rank potential recipients of media content items, according to an embodiment of the present disclosure. In some embodiments, the share sheet ranking module 106 of FIG. 1 can be implemented with the example share sheet ranking module 252. As shown in the example of FIG. 2B, the example share sheet ranking module 252 can include a ranking criteria module 254 and a ranking machine learning module 256.

The ranking criteria module 254 can rank potential recipients for a share sheet based on ranking criteria. Ranking criteria for a share sheet can include any criteria or information relevant for ranking potential recipients of a media content item to be shared. The ranking criteria can include one or more factors for ranking potential recipients. In certain embodiments, the ranking criteria can include factors, such as a share count for a potential recipient within a time period, a coefficient associated with a connection between a sharing user and a potential recipient in a social networking system, and a coefficient associated with a connection between a sharing user and a potential recipient in an application (or “app”) associated with a social networking system. The share count for a potential recipient can indicate a number of times a sharing user shared a media content item with the potential recipient within a time period. The time period can be specified in an appropriate unit of time, such as hour(s), day(s), month(s), etc. The coefficient associated with a connection between a sharing user and a potential recipient in a social networking system and the coefficient associated with a connection between a sharing user and a potential recipient in an application associated with a social networking system can be the same as or similar to the coefficients associated with connections between a sending user and a potential recipient described above in connection with a send sheet. The ranking criteria module 254 can rank potential recipients for a share sheet based on the one or more factors in the ranking criteria. For example, for a particular sharing user, a potential recipient having a higher share count within a specified time period can be ranked higher than a potential recipient having a lower share count within the specified time period. As another example, for a particular sharing user, a potential recipient having a higher value of a coefficient can be ranked higher than a potential recipient having a lower value of the coefficient. The ranking criteria module 254 can rank the potential recipients based on a combination of the one or more factors. In some embodiments, the one or more factors can be weighted. Many variations are possible.

The ranking machine learning module 256 can rank additionally or alternatively potential recipients for a share sheet based on machine learning techniques. For example, a machine learning model can be trained to rank potential recipients for a share sheet based on a likelihood of a sharing user engaging with the potential recipients. For example, the machine learning model can be trained based on training data that includes information relating to sharing users, recipients, and/or media content items that have been shared between sharing users and recipients. In certain embodiments, features for training the machine learning model can be selected from features described in connection with the send sheet ranking module 202. The ranking machine learning module 256 can train the machine learning model to output a ranking or a score indicative of a likelihood of a sharing user engaging with a potential recipient. All examples herein are provided for illustrative purposes, and there can be many variations and other possibilities.

Similar to the send sheet ranking module 202, the share sheet ranking module 252 can provide some or all of the ranked potential recipients in the share sheet based on the ranking. In some embodiments, all of the potential recipients can be provided in the share sheet in the order of the ranking. In other embodiments, one or more top ranked potential recipients can be provided in the share sheet as suggested recipients. As an example, one or more potential recipients having rankings or scores that satisfy a threshold value can be provided as suggested recipients. As another example, a predetermined number of top ranked potential recipients can be provided as suggested recipients. In these embodiments, the share sheet can also provide some or all remaining in an alphabetical order. In certain embodiments, the share sheet can also provide recent recipients. Many variations are possible. All examples herein are provided for illustrative purposes, and there can be many variations and other possibilities.

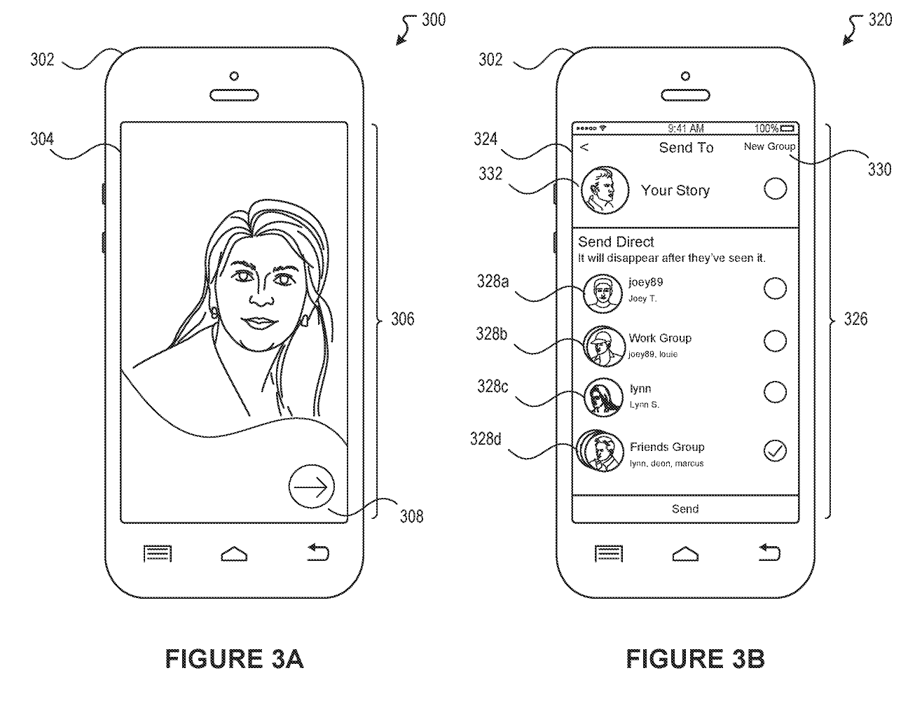

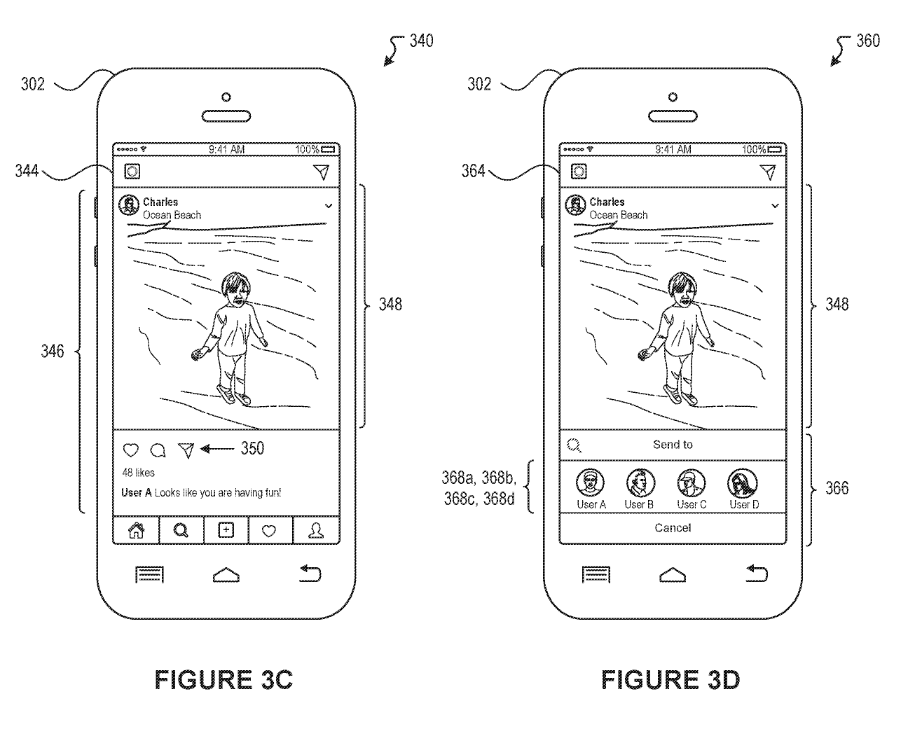

FIGS. 3A-3D illustrate example scenarios 300, 320, 340, and 360 for ranking potential recipients of content items, according to an embodiment of the present disclosure. FIGS. 3A-3B illustrate sending of a content item as an ephemeral message. In FIG. 3A, the example scenario 300 illustrates a computing device 302 displaying a user interface 304 associated with a social networking system. The user interface 304 shows a camera view associated with the computing device 302 in which a media content item 306 (e.g., an image, a video, etc.) has been captured. The user interface 304 can provide an option 308 for a user to send the captured media content item 306 as an ephemeral message. FIG. 3B illustrates the example scenario 320, in which a sending user has selected the option 308 in FIG. 3A to send the captured media content item 306 to one or more potential recipients as an ephemeral message. The example scenario 320 illustrates the computing device 302 displaying a user interface 324 that provides a send sheet 326. One or more potential recipients of the ephemeral message can be ranked by the content item recipient ranking module 102, as discussed herein. The send sheet 326 can provide at least some of the ranked potential recipients based on the ranking. As just one example, potential recipients 328a, 328b, 328c, 328d can be shown in an order of ranking and can correspond to four top-ranked potential recipients. The send sheet 326 can be scrolled to show additional potential recipients. Some potential recipients can be groups. For example, the potential recipient 328b and the potential recipient 328d are groups that include multiple users. In some embodiments, potential recipients can be represented by avatars. In certain embodiments, a sending user can create a new group by selecting an option 330. In some instances, a sending user can choose to add the captured media content item 306 to an ephemeral content collection of the sending user, instead of sending as an ephemeral message. In such instances, the sending user can select an option 332 to add the captured media content item 306 to the sending user's ephemeral content collection. In some embodiments, an ephemeral content collection can also be referred to as a “story.” All examples herein are provided for illustrative purposes, and there can be many variations and other possibilities.

FIGS. 3C-3D illustrate sharing of a media content item in a feed of a sharing user. In FIG. 3C, the example scenario 340 illustrates the computing device 302 displaying a user interface 344 associated with a social networking system. The user interface 344 shows a feed 346 of the sharing user. In the example of FIG. 3C, the feed 346 includes a media content item 348. The sharing user can select an option 350 to share the media content item 348 with one or more recipients. FIG. 3D illustrates the example scenario 360, in which the sharing user has selected the option 350 in FIG. 3C to share the media content item 348. The example scenario 360 illustrates the computing device 302 displaying a user interface 364 that provides a share sheet 366 in the feed 346. One or more potential recipients of the media content item 348 can be ranked by the content item recipient ranking module 102, as discussed herein. The share sheet 366 can provide at least some of the ranked potential recipients based on the ranking. For example, potential recipients 368a, 368b, 368c, 368d can be shown in an order of ranking and can correspond to four top-ranked potential recipients. The potential recipients 368a, 368b, 368c, and 368d correspond to User A, User B, User C, and User D, respectively. The share sheet 366 or a portion of the share sheet 366 displaying the potential recipients 368 can be scrolled to show additional potential recipients. Some potential recipients can be groups. In some embodiments, potential recipients can be represented by avatars. After the sharing user selects one or more recipients from the share sheet 366, the media content item 348 can be sent to the one or more recipients. In some embodiments, the media content item 348 can be sent as or in a message to the one or more recipients. In other embodiments, the media content item 348 can be provided in a user interface associated with the one or more recipients. All examples herein are provided for illustrative purposes, and there can be many variations and other possibilities.

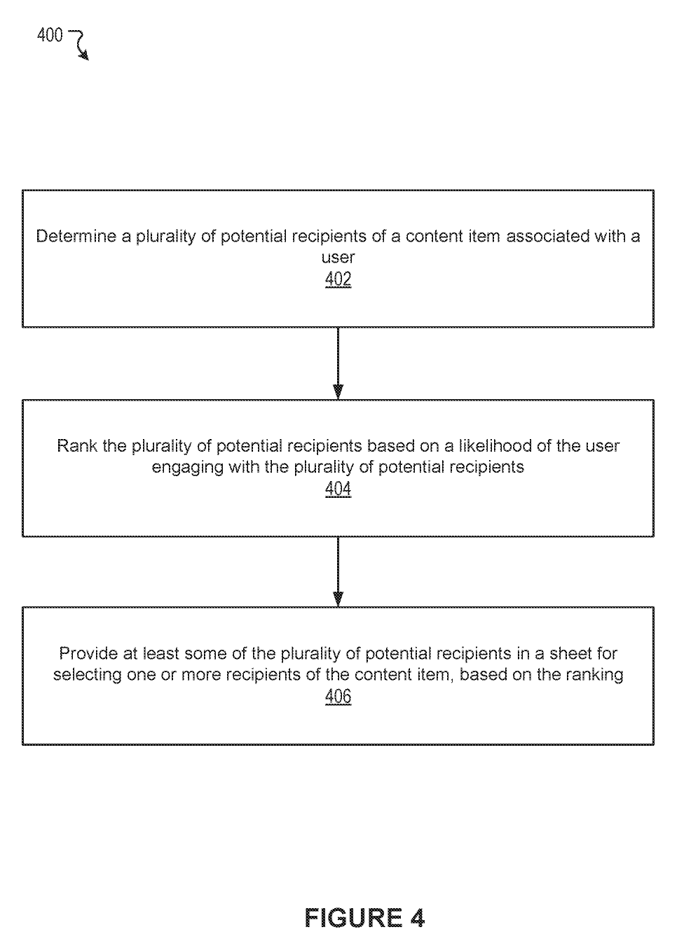

FIG. 4 illustrates an example first method 400 for ranking potential recipients of content items, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can determine a plurality of potential recipients of a content item associated with a user. At block 404, the example method 400 can rank the plurality of potential recipients based on a likelihood of the user engaging with the plurality of potential recipients. At block 406, the example method 400 can provide at least some of the plurality of potential recipients in a sheet for selecting one or more recipients of the content item, based on the ranking. Other suitable techniques that incorporate various features and embodiments of the present disclosure are possible.

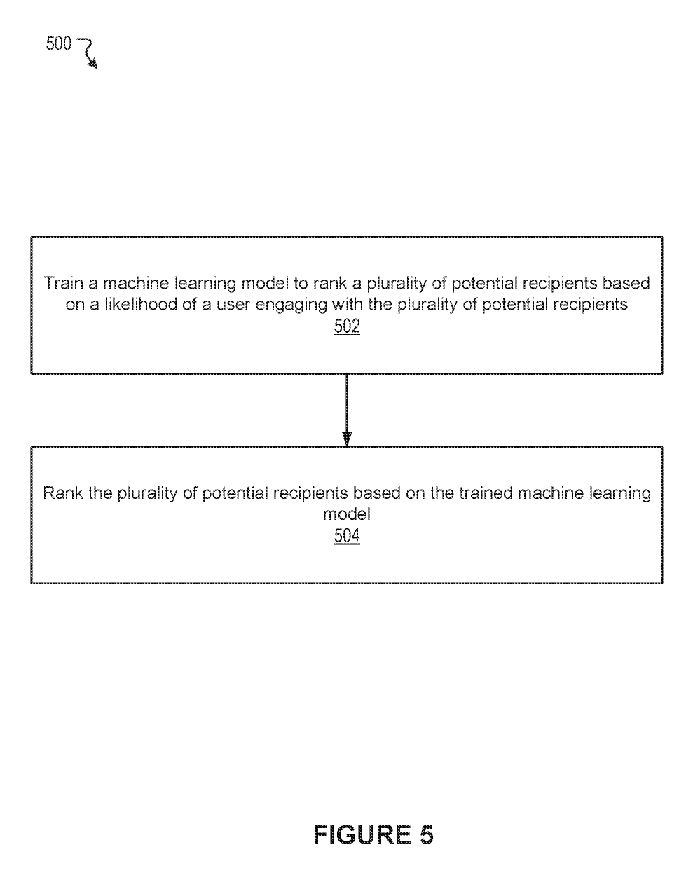

FIG. 5 illustrates an example second method 500 for ranking potential recipients of content items, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can train a machine learning model to rank a plurality of potential recipients based on a likelihood of a user engaging with the plurality of potential recipients. The plurality of potential recipients can be similar to the plurality of potential recipients explained in connection with FIG. 4. The user can be similar to the user explained in connection with FIG. 4. At block 504, the example method 500 can rank the plurality of potential recipients based on the trained machine learning model. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content item recipient ranking module 646. The content item recipient ranking module 646 can be implemented with the content item recipient ranking module 102, as discussed in more detail herein. In some embodiments, one or more functionalities of the content item recipient ranking module 646 can be implemented in the user device 610.

### Hardware Implementation

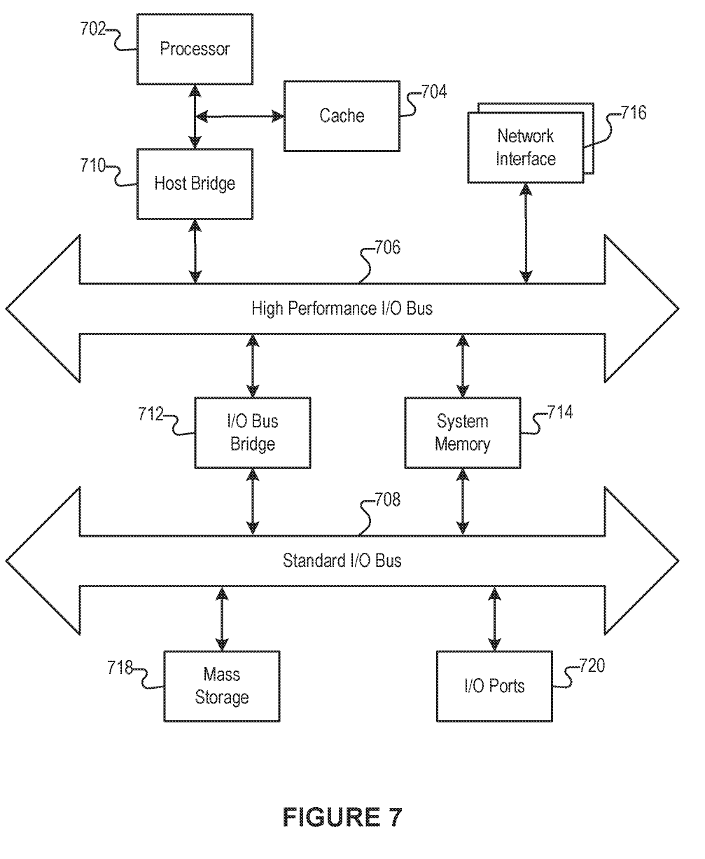

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a plurality of potential recipients of a content item associated with a user;
ranking, by the computing system, the plurality of potential recipients based on a likelihood of the user engaging with the plurality of potential recipients; and
providing, by the computing system, at least some of the plurality of potential recipients in a sheet for selecting one or more recipients of the content item, based on the ranking.

2. The computer-implemented method of claim 1, wherein the content item is an ephemeral message and the sheet for selecting one or more recipients is a send sheet for the ephemeral message.

3. The computer-implemented method of claim 2, wherein the ranking the plurality of potential recipients is based on ranking criteria.

4. The computer-implemented method of claim 3, wherein the ranking criteria includes one or more of: a send count for ephemeral message to a potential recipient within a time period, a send count for messages to a potential recipient within a time period, a receive count for ephemeral messages from a potential recipient within a time period, a receive count for messages from a potential recipient within a time period, a coefficient associated with a connection between the user and a potential recipient in a social networking system, or a coefficient associated with a connection between the user and a potential recipient in an application associated with a social networking system.

5. The computer-implemented method of claim 2, wherein the ranking the plurality of potential recipients is based on a machine learning model.

6. The computer-implemented method of claim 5, wherein the machine learning model is trained based on features relating to one or more of: user attributes, message attributes, or interaction attributes.

7. The computer-implemented method of claim 1, wherein the content item is a media content item in a feed of the user and the sheet for selecting one or more recipients is a share sheet for sharing the media content item.

8. The computer-implemented method of claim 7, wherein the ranking the plurality of potential recipients is based on ranking criteria.

9. The computer-implemented method of claim 8, wherein the ranking criteria includes one or more of: a share count for a potential recipient within a time period, a coefficient associated with a connection between the user and a potential recipient in a social networking system, or a coefficient associated with a connection between the user and a potential recipient in an application associated with a social networking system.

10. The computer-implemented method of claim 1, wherein the plurality of potential recipients includes one or more of: a connection of the user, or a group that includes a connection of the user.

11. A system comprising:
at least one hardware processor; and
a memory storing instructions that, when executed by the at least one processor, cause the system to perform:
determining a plurality of potential recipients of a content item associated with a user;
ranking the plurality of potential recipients based on a likelihood of the user engaging with the plurality of potential recipients; and
providing at least some of the plurality of potential recipients in a sheet for selecting one or more recipients of the content item, based on the ranking.

12. The system of claim 11, wherein the content item is an ephemeral message and the sheet for selecting one or more recipients is a send sheet for the ephemeral message.

13. system of claim 12, wherein the ranking the plurality of potential recipients is based on ranking criteria.

14. system of claim 12, wherein the ranking the plurality of potential recipients is based on a machine learning model.

15. system of claim 11, wherein the content item is a media content item in a feed of the user and the sheet for selecting one or more recipients is a share sheet for sharing the media content item.

16. A non-transitory computer readable medium including instructions that, when executed by at least one hardware processor of a computing system, cause the computing system to perform a method comprising:
determining a plurality of potential recipients of a content item associated with a user;
ranking the plurality of potential recipients based on a likelihood of the user engaging with the plurality of potential recipients; and
providing at least some of the plurality of potential recipients in a sheet for selecting one or more recipients of the content item, based on the ranking.

17. The non-transitory computer readable medium of claim 16, wherein the content item is an ephemeral message and the sheet for selecting one or more recipients is a send sheet for the ephemeral message.

18. The non-transitory computer readable medium of claim 17, wherein the ranking the plurality of potential recipients is based on ranking criteria.

19. The non-transitory computer readable medium of claim 17, wherein the ranking the plurality of potential recipients is based on a machine learning model.

20. The non-transitory computer readable medium of claim 16, wherein the content item is a media content item in a feed of the user and the sheet for selecting one or more recipients is a share sheet for sharing the media content item.
